(19) United States
(12) Patent Application Publication
(10) Pub. No.: US 2018/0107500 A1
(43) Pub. Date: Apr. 19, 2018

(54) METHOD TO RUN REAL-TIME SOFTWARE APPLICATIONS ON TOP OF GENERAL VIRTUAL MACHINE

(71) Applicant: ASOCS Ltd., Rosh Haayin (IL)

(72) Inventors: Gilad GARON, Jerusalem (IL); Gaby GURI, Oranit (IL); Yaniv SHAKED, Rosh Haayin (IL)

(21) Appl. No.: 15/787,324

(22) Filed: Oct. 18, 2017

Related U.S. Application Data
(60) Provisional application No. 62/409,487, filed on Oct. 18, 2016.

(51) Int. Cl. G06F 9/455

(52) U.S. Cl. CPC G06F 9/45529

(57) ABSTRACT

A method and system are described that support proper operation of RTSA by providing it the required real-time resources at the right time. The method and system include three elements: Isolation, Independence, and Timing limited/non-blocking interfaces. Isolation defines to the host operating system and any other element involved that the CPU core or few CPU cores that are used to run the RTSA should be isolated, be in full ownership of the RTSA, and cannot serve any general purpose task of the platform. Independence is an attribute or characteristic that the code used in the RTSA preferably does not use any external service/device unless the service/device has a clear known deterministic real-time characteristic. Timing limited/non-blocking interfaces is an attribute or characteristic that, in cases where interfaces between the RTSA to other software program is needed, the interface should preferably be limited in effecting the timing operation of the RTSA.

### CROSS-REFERENCE TO RELATED APPLICATION

This application is based upon and claims priority to U.S. provisional patent application No. 62/409,487, entitled “A Method to Run Real-Time Software Applications on Top of General VM,” filed 18 Oct. 2016, attorney docket number 066940-0074; the entire content of that referenced provisional application is incorporated herein by reference.

### BACKGROUND

A real-time system is typically built from a real-time software application (RTSA) running on top of RTOS (real-time operating system) in an embedded hardware platform. Developers have been trying to use standard, non-real-time compute (or, computing) platforms (e.g. servers or personal computers) instead of embedded platforms in order to benefit from the cost advantages and ubiquity derived from the high availability of such platforms, as well as the time-to-market. Designing a real-time application on standard platform requires special care in order to ensure the required performance.

Lately a new type of platforms has been widely used: the virtual machine (VM). This is not a real hardware platform but a virtualized platform emulated on top of a classical compute platform. A new challenge is presented by the VM: running real-time software applications on top of VM.

FIG. 1 illustrates a block diagram of a general compute platform 100 with several cores, and VMs running on top of a virtualization Layer. Platform 100 includes three virtual machines (VMs) 102-1, 102-2, and 102-3, and a virtualization layer 104, as shown. Platform 100 also includes a compute platform 106 and a number of cores, e.g., cores 108-1, 108-2, . . . , 108-N (e.g., virtual cores).

The main challenge of running RTSA on a VM is to guarantee that the target application gets the required computation resources when those are needed. The following example can be used to demonstrate the problem.

As an example, an assumption can be made that an RTSA that needs 100% of the core computation power for 100 microseconds every 1 msec. On average, the RTSA requires only 10% of the core computation power. A second assumption can be made that a different software application is used for heat dissipation management that reads temperature sensors and controls the speed of some fans, and that this needs to be executed every minute for about 10 msec. On average this management application takes 0.016% of the core computation power. The two applications take together 10.016% of the core computation power, nevertheless because of the real time behavior of the first application (its need for CPU power precisely every 1 msec) running the two applications together become problematic

### SUMMARY

Aspects and embodiments of the present disclosure address and provide features and techniques for dealing with the above-described challenge. One aspect of the present disclosure presents a method and system that support proper operation of RTSA by providing it the required real-time resources at the right time. The method and system include three elements: Isolation, Independence, and Timing limited/non-blocking interfaces.

Isolation is an attribute or characteristic that defines to the host operating system and any other element involved that the CPU core or few CPU cores that are used to run the RTSA should be isolated, be in full ownership of the RTSA, and cannot serve any general purpose task of the platform.

Independence is an attribute or characteristic that the code used in the RTSA preferably does not use any external service/device unless the service/device has a clear known deterministic real-time characteristic.

Timing limited/non-blocking interfaces is an attribute or characteristic that, in cases where interfaces between the RTSA to other software program is needed, the interface should preferably be limited in effecting the timing operation of the RTSA.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a block diagram of a general compute platform with several cores, and virtual machines (VMs) running on top of a virtualization Layer.

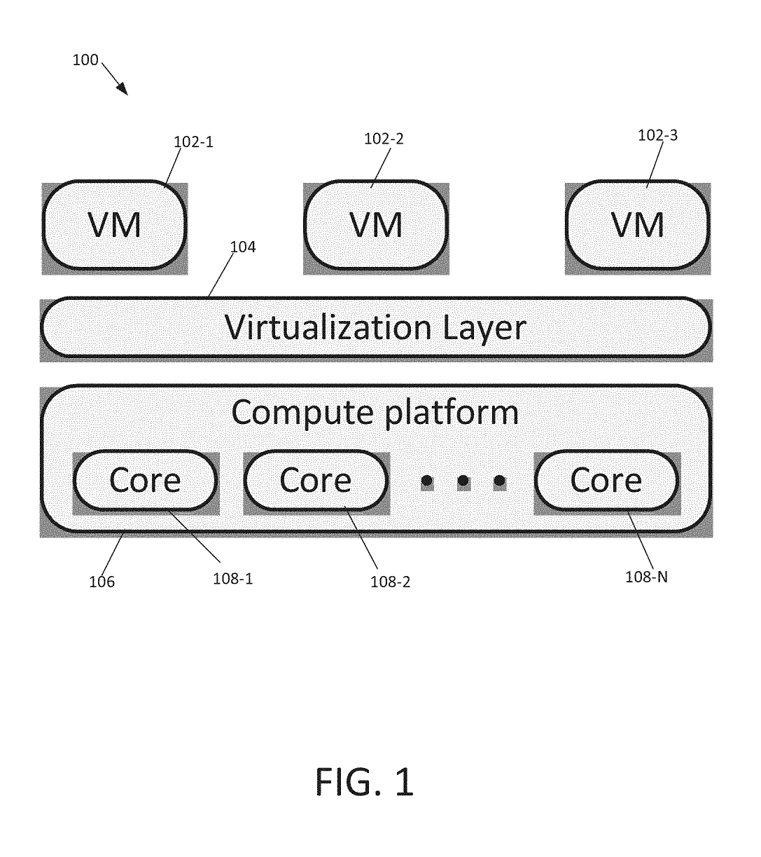

FIG. 2 illustrates an embodiment of a real time software application (RTSA) virtual machine (VM) running on a dedicated core and interfacing other regular virtual machines (VMs), in accordance with the presence disclosure.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

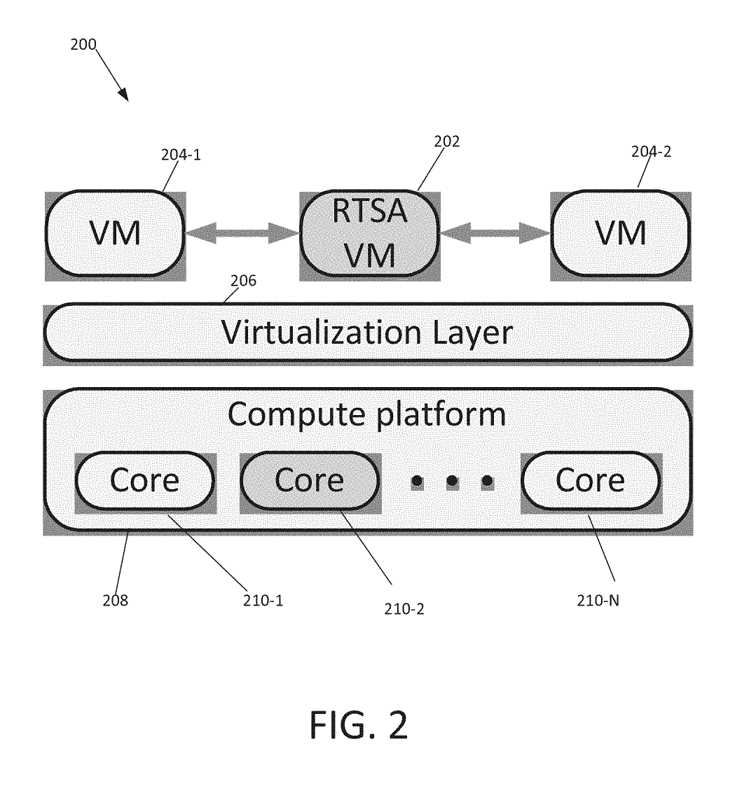

FIG. 2 illustrates an embodiment 200 of real time software application (RTSA) virtual machine (VM) running on a dedicated core and interfacing other regular VMs, in accordance with the present disclosure. Embodiment 200 includes RTSA VM 202 and VMs 204-1 and 204-2, as shown. Embodiment 200 also includes a virtualization layer 206 and a compute platform 208, as shown. A number of cores 210-1, 210-2, . . . , 210-N are also included.

The method and system described below, e.g., embodiment 200, support proper operation of RTSA by providing it the required real-time resources at the right time. The method and system include three elements: Isolation, Independence, and Timing limited/non-blocking interfaces.

Isolation: define to the host operating system and any other element involved that the CPU core or few CPU cores that are used to run the RTSA should be isolated, be in full ownership of the RTSA, and cannot serve any general purpose task of the platform.

For example, the following scenario can be assumed: Platform with two (2) CPUs, 8 core each. CPU 0 core indexes 0-7, CPU 1 core indexes 8-15. The Platform is running Fedora Linux OS. An Openstack service (Nova agent) is running on this platform, allowing this platform to be managed by the cloud infrastructure. Platform is also running some housekeeping tasks: cleaning temporary files. The RTSA of the present disclosure runs on this platform, consuming 2 CPU cores. For the given example, Isolation relates to the ability to define to Fedora Linux OS and to the Openstack service that two cores (For example, core 5 and core 6) are allocated for the ownership of the RTSA, so that no tasks (housekeeping tasks or any other tasks) will be running on those cores. The only task allowed to run on those cores is the RTSA.

Independence: the code used in the RTSA preferably does not use any external service/device unless the service/device has a clear known deterministic real-time characteristic.

For example, assume the following scenario: A communication system is used to transfer confidential information between two geographical locations. A RTSA is running at both ends, one used to cipher the data and the other to decipher the data. The incoming data rate is 10K messages per second, and the RTSA uses an external cipher acceleration device to cipher/decipher the messages. The cipher acceleration device cipher/decipher rate is 15K messages per second. For the given example, Independence relates to the fact the RTSA is using an external device whose real-time behavior is well known and deterministic—15K message per second. In addition, there are no other applications using the same device at the same time. For example, getting computation services from a mathematical co-processor that serves other cores must be avoided.

Timing limited/non-blocking interfaces: in cases where interfaces between the RTSA to other software program is needed, the interface should preferably be limited in effecting the timing operation of the RTSA. For example, usage of lock/unlock mechanisms in the interfaces should be avoided. Another example is using a non-blocking producer-consumer scheme for transferring data over shared memory between the programs.

For example, assume the following scenario: An electronic warfare (EW) system is sending electronic signals to neutralize enemy combat capability. The EW system software implementation is divided into two applications, where the lower level application is connected to the antenna, and receives information from a higher level application. The low level application is a RTSA due to its nature. To maintain system operational, this information has to be transferred every 10 milliseconds (originated from the high level application to the low level application).

For the given example, using a timing limited/non-blocking interface relates to the characteristics of the interface between the high level application and the low level application. For example, using a non-blocking producer-consumer scheme for transferring the information between the applications is a solution satisfying this requirement.

By using this method and running RTSA on VM, it can open an opportunity to wide range of application moving from embedded platform into standard computation platforms. The RTSA can be application serving the communication segment, automotive, or any other type of market. The VM can be a classical virtual machine, container or any other virtualization technique. The computation platform can be or include a x86 server or OCP, it can be single server or a cloud, it can be local platform or distributed one.

Unless otherwise indicated, systems and techniques that have been discussed herein are implemented with a specially-configured computer system specifically configured to perform the functions that have been described herein for the component/step. Each computer system can include one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system may be or include a desktop computer or a portable computer, such as a laptop computer, a notebook computer, a tablet computer, a PDA, a smartphone, or part of a larger system, such a vehicle, appliance, and/or telephone system.

Each computer system may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

What is claimed is:

1. A compute platform implementing a real time software application (RTSA) virtual machine (VM), the system comprising:
a real time software application (RTSA) virtual machine (VM) configured for running on a dedicated core;
at least one virtual machine (VM) configured for interfacing with the RTSA VM;
a virtualization layer;
a compute platform; and
a plurality of cores configured in the compute platform.
